(19) United States
(12) Patent Application Publication
(10) Pub. No.: US 2009/0007376 A1
(43) Pub. Date: Jan. 8, 2009

(54) Stable hinge

(75) Inventor: Tzu-Yu Lin, Shulin City (TW)

Correspondence Address: Joe McKinney Muncy, PO Box 1364, Fairfax, VA, 22038-1364, US

(73) Assignee: SHIN ZU SHING CO., LTD.

(21) Appl. No.: 11/822,379

(22) Filed: Jul. 5, 2007

(51) Int. Cl. E05D 7/10

(52) U.S. Cl. 16/263; 16/350; 16/387

(57) ABSTRACT

A stable hinge keeps elements of the hinge from shaking and has a pivoting assembly, a stabilizer and a stationary assembly. The pivoting assembly attaches the stable hinge to a cover of an electronic device and has a standoff, a leaf and a barrel. The standoff has a proximal edge, a distal edge and a notch formed in the proximal edge. The leaf is formed longitudinally on and protrudes from the distal edge. The barrel is formed longitudinally on the proximal edge and has a slot. The stabilizer is mounted in the slot and to the standoff. The stationary assembly attaches to a base of an electronic device and is mounted rotatably in the barrel and through the stabilizer to stabilize the hinge and give the stable hinge a longer useful life.

### BACKGROUND OF THE INVENTION

1. Field of the Invention

The present invention relates to a hinge, especially to a stable hinge mounted between a cover and a base of an electronic device and will keep the cover from shaking.

2. Description of the Related Art

Electronic devices, such as laptops, cell phones and the like, usually have a base and a corresponding cover. A conventional hinge is connected to the base and the cover to allow the cover to pivot open or closed. The cover has a center of gravity that is a significant distance away from the hinge. The center of gravity and the distance cause a moment to be generated in the cover when the cover is pivoted around the hinge. The moment causes the hinge and the cover to shake. The shaking problem shortens the useful life of the convention hinge.

### SUMMARY OF THE INVENTION

The objective of the present invention is to provide a stable hinge that will cause a cover of an electronic device to pivot smoothly and keep the cover from shaking to lengthen the hinge's useful life.

A stable hinge in accordance with the present invention keeps elements of the hinge from shaking and comprises a pivoting assembly, a stabilizer and a stationary assembly. The pivoting assembly attaches the stable hinge to a cover of an electronic device and has a standoff, a leaf and a barrel. The standoff has a proximal edge, a distal edge and a notch formed in the proximal edge. The leaf is formed longitudinally on and protrudes from the distal edge. The barrel is formed longitudinally on the proximal edge and has a slot. The stabilizer is mounted in the slot and to the standoff. The stationary assembly attaches to a base of an electronic device and is mounted rotatably in the barrel and through the stabilizer to stabilize the hinge and give the stable hinge a longer useful life.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a stable hinge in accordance with the present invention;

FIG. 2 is a perspective view of a second embodiment of a stable hinge in accordance with the present invention;

FIG. 3 is an exploded perspective view of the stable hinge in FIG. 1;

FIG. 4 is an exploded perspective view of the stable hinge in FIG. 2;

FIG. 5 is a top view of the stable hinge in FIG. 1; and

FIG. 6 is a right side view in partial section of the stable hinge along line 6-6 in FIG. 5.

### DETAILED DESCRIPTION OF THE PREFERRED EMBODIMENTS

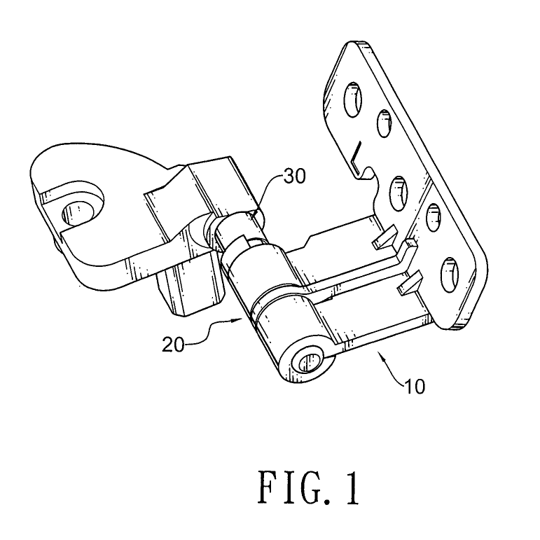

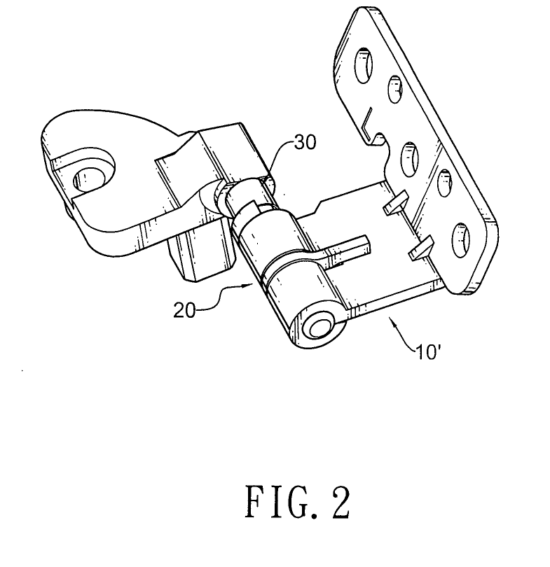

With reference to FIGS. 1 and 2, a stable hinge in accordance with the present invention comprises a pivoting assembly (10, 10′), a stabilizer (20, 20′) and a stationary assembly (30).

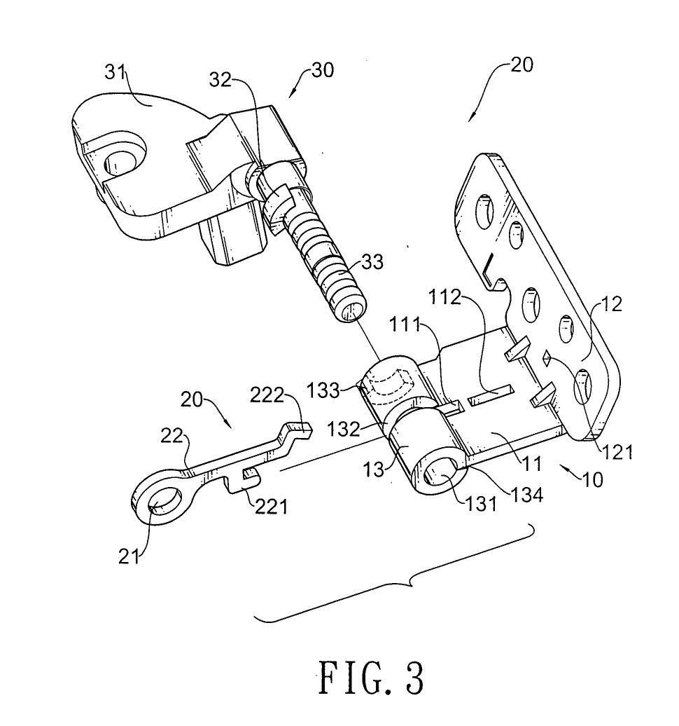

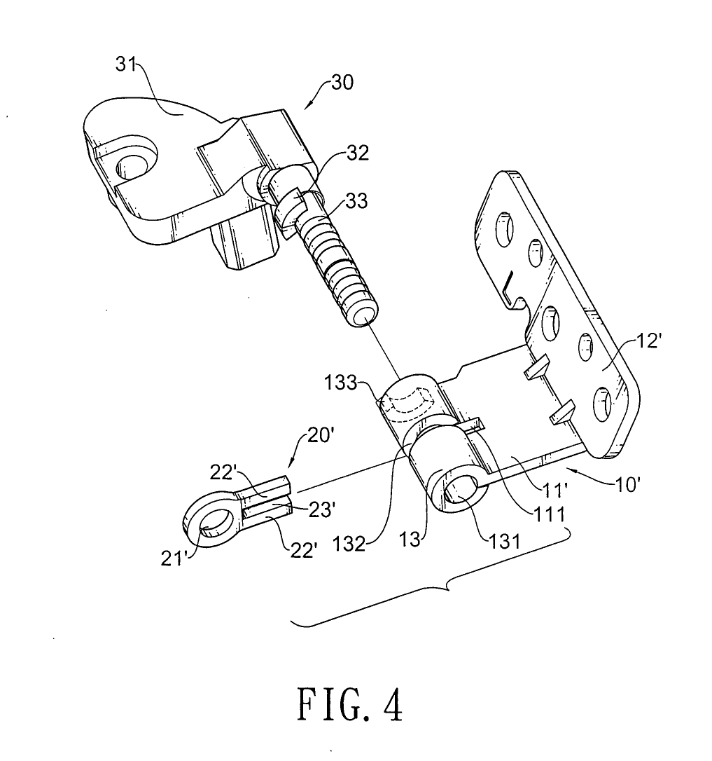

With further reference to FIGS. 3 and 4, the pivoting assembly (10, 10′) has a standoff (11, 11′), a leaf (12) and a barrel (13).

The standoff (11, 11′) has a proximal edge, a distal edge, a notch (111) and an optional locking slot (112). The notch (111) is formed in the proximal edge of the standoff (11, 11′). The locking slot (112) is formed through the standoff (11) between the proximal and distal edges and is aligned with the notch (111).

The leaf (12, 12′) is formed longitudinally on and protrudes from the distal edge of the standoff (11, 11′) at an angle and has a proximal edge and an optional locking hole (121). The locking hole (121) is formed through the leaf (12) near the proximal edge and in line with the locking slot (112) and the notch (111).

The barrel (13) is formed longitudinally on the proximal edge of the standoff (11, 11′) and has two ends, a pivot hole (131), a slot (132), an optional limit (133) and a gap (134). The slot (132) is formed transversely through the barrel (13) and corresponds to and aligns and communicates with the notch (111) in the standoff (11, 11′). The limit (133) is curved and is formed on and protrudes longitudinally from one end of the barrel (13). The gap (134) is formed longitudinally in the barrel (13) between the barrel (13) and the standoff (11, 11′).

The stabilizer (20, 20′) is mounted in the slot (132) in the barrel (12) and the notch (111) and the locking slot (12) in the standoff (11, 11′), keeps the pivoting assembly (10, 10′) from shaking and has two ends, a through hole (21) and a connecting shaft (22, 22′).

The through hole (21) is formed transversely through the stabilizer (20, 20′) near one end, is mounted in the slot (132) in the barrel (13) and corresponds to and aligns with the pivot hole (131) through the barrel (13).

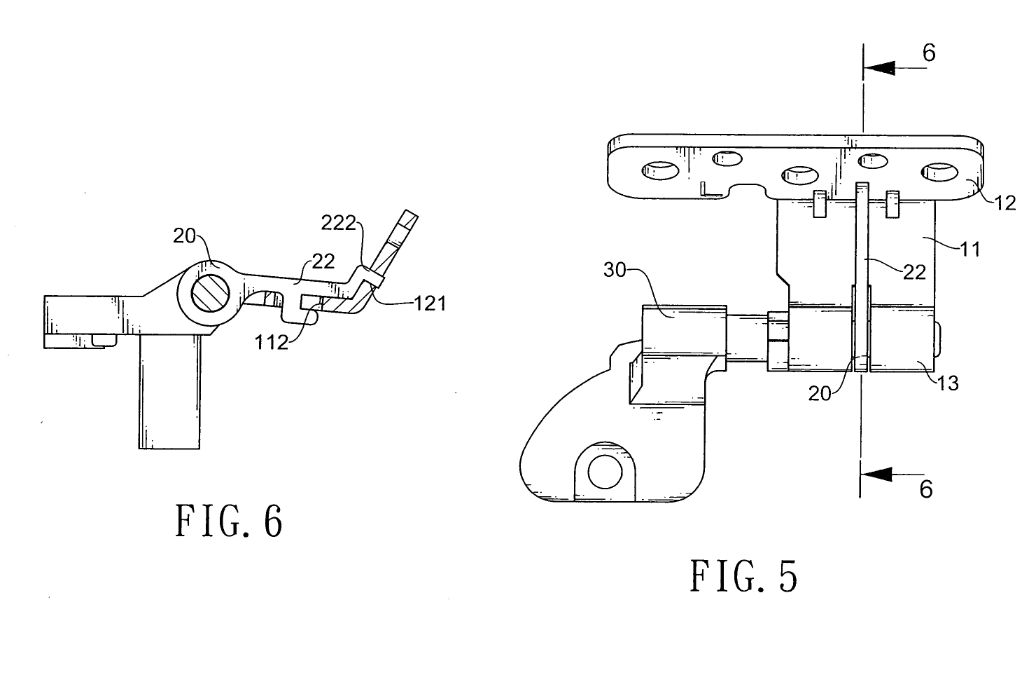

The connecting shaft (22, 22′) protrudes from the barrel (13), is connected to the standoff (11, 11′) and may be implemented as two parallel prongs or a single prong. The connecting shaft (22′) implemented with two parallel prongs has a notch between the parallel prongs that corresponds to and is mounted securely in the notch (111) in the distal edge of the standoff (11′). With further reference to FIGS. 5 and 6, the connecting shaft (22) implemented with a single prong is also connected to the leaf (12) and has a single prong, a hook connector (221) and a tab connector (222). The single prong has a bottom edge and a distal end. The hook connector (221) is L-shaped, is formed on and protrudes from the bottom edge of the single prong toward the distal end and is mounted securely in the locking slot (112). The tab connector (222) is formed on and protrudes from the distal end of the single prong and is mounted in the connecting hole (121) in the leaf (12).

The stationary assembly (30) is attached to a base of an electronic device, is mounted pivotally in the barrel (13) and the stabilizer (20) and has a proximal end, a distal end, an optional stationary leaf (31), a pintle (33) and an optional positive stop (32).

The proximal end is attached to the base of an electronic device and has a front edge and an inner end.

The stationary leaf (31) is formed on and protrudes transversely from the front edge of the proximal end of the stationary assembly (30) and attaches the proximal end of the stationary assembly (30) to a base of an electronic device.

The pintle (33) is formed on and protrudes from the inner end of the proximal end of the stationary leaf (31), is mounted pivotally in the pivot hole (131) in the barrel (13) and through the through hole (21) in the stabilizer (20, 20′) that keeps the pivoting assembly (10, 10′) from shaking when the pivoting assembly (10, 10′) pivots and has a proximal end.

The positive stop (32) is curved, is formed on and protrudes radially from the proximal end of the pintle (33), selectively abuts the limit (133) to allow the pivoting assembly (10, 10′) to pivot with a desired arc and subtends a desired angle.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A stable hinge comprising:
a pivoting assembly having:
a standoff having
a proximal edge;
a distal edge; and
a notch being formed in the proximal edge;
a leaf being formed longitudinally on and protruding from the distal edge of the standoff at an angle and having a proximal edge; and
a barrel the barrel being formed longitudinally on the proximal edge of the standoff and having
two ends;
a pivot hole;
a slot being formed transversely through the barrel and corresponding to and aligning and communicating with the notch in the standoff, and
a gap being formed longitudinally in the barrel between the barrel and the standoff;
a stabilizer being mounted in the slot in the barrel and the notch in the standoff and having
two ends;
a through hole being formed transversely through the stabilizer near one end, being mounted in the slot in the barrel and corresponding to and aligning with the pivot hole through the barrel; and
a connecting shaft protruding from the barrel and being connected to the standoff;
a stationary assembly being mounted pivotally in the barrel and the stabilizer and having
a proximal end;
a distal end; and
a pintle.

2. The stable hinge as claimed in claim 1, wherein
the standoff further has a locking slot formed through the standoff between the proximal and distal edges and aligned with the notch;
the leaf on the pivoting assembly further has a locking hole formed through the leaf near the proximal edge and in line with the locking slot and the notch;
the stabilizer is further mounted in the locking slot in the standoff; and
the connecting shaft of the stabilizer is implemented as a single prong and is connected to the leaf and has
a single prong having
a bottom edge; and
a distal end;
a hook connector being L-shaped, being formed on and protruding from the bottom edge of the single prong toward the distal end and being mounted securely in the locking slot; and
a tab connector being formed on and protruding from the distal end of the single prong and being mounted in the connecting hole in the leaf.

3. The stable hinge as claimed in claim 1, wherein the connecting shaft is implemented as two parallel prongs and has a notch between the parallel prongs that corresponds to and is mounted securely in the notch in the distal edge of the standoff.

4. The stable hinge as claimed in claim 1, wherein
the barrel further has a limit being curved and formed on and protruding longitudinally from one end of the barrel; and
the stationary assembly further has a positive stop being curved and formed on and protruding radially from the proximal end of the pintle, selectively abutting the limit and subtending an angle.

5. The stable hinge as claimed in claim 2, wherein
the barrel further has a limit being curved and formed on and protruding longitudinally from one end of the barrel; and
the stationary assembly further has a positive stop being curved and formed on and protruding radially from the proximal end of the pintle, selectively abutting the limit and subtending an angle.

6. The stable hinge as claimed in claim 3, wherein
the barrel further has a limit being curved and formed on and protruding longitudinally from one end of the barrel; and
the stationary assembly further has a positive stop being curved and formed on and protruding radially from the proximal end of the pintle, selectively abutting the limit and subtending an angle.

7. The stable hinge as claimed in claim 1, wherein the stationary assembly further has a stationary leaf formed on and protruding transversely from the front edge of the proximal end of the stationary assembly.

8. The stable hinge as claimed in claim 2, wherein the stationary assembly further has a stationary leaf formed on and protruding transversely from the front edge of the proximal end of the stationary assembly.

9. The stable hinge as claimed in claim 3, wherein the stationary assembly further has a stationary leaf formed on and protruding transversely from the front edge of the proximal end of the stationary assembly.

10. The stable hinge as claimed in claim 4, wherein the stationary assembly further has a stationary leaf formed on and protruding transversely from the front edge of the proximal end of the stationary assembly.

11. The stable hinge as claimed in claim 4, wherein the stationary assembly further has a stationary leaf formed on and protruding transversely from the front edge of the proximal end of the stationary assembly.

12. The stable hinge as claimed in claim 5, wherein the stationary assembly further has a stationary leaf formed on and protruding transversely from the front edge of the proximal end of the stationary assembly.
